(19) United States
(12) Patent Application Publication
(10) Pub. No.: US 2003/0103354 A1
(43) Pub. Date: Jun. 5, 2003

(54) Lamp

(76) Inventor: Ivo Niermann, Hannover (DE)

Correspondence Address: KENYON & KENYON, One Broadway, New York, NY, 10004, US

(21) Appl. No.: 10/334,188

(22) Filed: Dec. 30, 2002

Related U.S. Application Data
(63) Continuation of application No. 09/851,851, filed on May 9, 2001, now abandoned.

(51) Int. Cl. F21V 1/00

(52) U.S. Cl. 362/317

(57) ABSTRACT

The present invention relates to a lamp including a hollow body, in particular a glass cylinder, which accommodates a light source. The object of the present invention is to devise a lamp using simple means which is usable both for light sources with open flame and for electrically operated light sources, which is manufacturable in one piece, and whose emitted color and decoration can be changed in a quick and simple manner. The inner hollow body is surrounded by an outer hollow body, and both hollow bodies are interconnected at their top ends. The inner hollow body is shorter than the outer hollow body and carries an inwardly directed rim. The two hollow bodies may be composed of transparent glass which is smooth on the inside and on the outside. This lamp, which is composed of two hollow bodies and in which the shorter inner cylinder is arranged axially parallel or coaxially inside the outer cylinder, does not require a base since the function thereof is taken on by the lower part of the longer outer cylinder. The inwardly directed rim of the shorter inner hollow body constitutes a support for a candle inserted from above.

### BACKGROUND OF THE INVENTION

The present invention relates to a lamp including a hollow body made of light-transmissive material, in particular a glass cylinder, which accommodates a light source.

Lamps of this kind exist in great numbers both for night light candles, normal candles, or other light sources having an open flame, and for electrically operated light sources. The hollow body is mostly a glass cylinder which is open at the top and at the bottom. In all these lamps, the glass cylinder is removably put or pushed onto a base and, in the case of the lamps having an open flame, serves as a wind protection and, in all these lamps, as a protection against contact as well as for the scattering of the light.

If only because of the need for a base, these lamps have to be composed of several parts which require a shared multipart packing and which need to be assembled prior to initial operation.

The glass cylinder of these lamps can also be composed of ornamental glass, milk glass, and dyed glass. However, nobody has thought of the possibility of changing such cylinders to change the room decoration and room atmosphere.

When using lamps of this kind as a storm lamp in the open air, for example at garden parties, it is often desired to use cylinders of different colors. This means for the dealer that he must maintain an extensive stock of the differently colored cylinders for this kind of lamps if a changing of the cylinders or of other lampshades is provided at all.

### SUMMARY OF THE INVENTION

The present invention avoids the disadvantage of the related art. The object of the present invention is to devise a lamp of the type mentioned at the outset using simple means which is usable both for light sources with open flame and for electrically operated light sources, and which is manufacturable in one piece, and whose emitted color and decoration can be changed in a quick and simple manner.

The present invention is comprised of an inner hollow body surrounded by an outer light-transmissive hollow body, wherein both hollow bodies are interconnected at their top ends, and wherein the inner hollow body is shorter than the outer hollow body and carries an inwardly directed rim.

In a preferred embodiment, the light-transmissive hollow bodies are glass cylinders, however, other hollow body shapes such as spherical cups or other hollow bodies which are open at the top and at the bottom, bulbous hollow bodies as well as hollow bodies having triangular or polygonal cross-sections can also be used, whether they are composed of glass, plastic or other light-transmissive material.

These hollow bodies have the feature of being provided with a hole on two opposing sides. The two hollow bodies will preferably be cylinders and be composed of a ornamental glass which produces light effects or of transparent glass which is smooth on the inside and on the outside.

According to the present invention, these two hollow bodies are joined to form only one piece, most simply in that the connection between the two hollow bodies at their top ends is a ring which is made of light-transmissive material and which, at its edges, merges into the upper edges of the hollow bodies.

In an easily manufacturable embodiment, the ring is made of light-transmissive material and is formed as an inwardly directed rim at the upper or top end of the outer hollow body or as an outwardly directed rim at the upper or top end of the inner hollow body.

This lamp, which is composed of two hollow bodies and in which the shorter inner hollow body is arranged axially parallel or coaxially inside the outer hollow body, does not need any base since the function thereof is taken on by the lower part of the longer outer hollow body. The inwardly directed rim of the shorter inner hollow body constitutes a support for a night light candle which is inserted from above or for a normal candle which is inserted from above, it being expedient for the hollow bodies to have a height and for the central hole in the rim of the inner glass cylinder to have a width which permit a night light candle, which is inserted in the lamp, to be lifted to such an extent that it can be lit by a match, a lighter or a lighting aid.

This lamp, which is composed of two hollow bodies and in which the shorter inner hollow body is arranged axially parallel or coaxially inside the outer hollow body, has also a support for the base of an electrically operated incandescent bulb or another electrically operated light source in the inwardly directed rim of the inner hollow body. The electrically operated light source has a base including a rim and a spring collar. The rim of the base engages on one side of the rim of the inner glass cylinder and the spring collar engages on the other side of the rim of the inner glass cylinder.

This lamp, which is composed of two hollow bodies and in which the shorter inner hollow body is arranged axially parallel or coaxially inside the outer hollow body, can be manufactured in one piece, for example, from glass, in that, at the upper edge, the inner hollow body has an outwardly directed rim or in that the outer hollow body has an inwardly directed rim which is fixedly joined to (fused together with) the other hollow body, respectively.

However, if this lamp, which is composed of two hollow bodies and in which the shorter inner hollow body is arranged axially parallel or coaxially inside the outer hollow body, is made from plastic, then it can manufactured in one piece, for example by injection molding, using a very simple mold which is composed of turned parts only.

An important feature of this lamp, which is composed of two cylindrical hollow bodies, is the annular hollow space between the two hollow bodies since this means allows a decoration to be inserted in the space between the two hollow bodies.

The decoration can be, for example, a printed or painted paper, or a film, or a piece of textile, and/or a lens or an ensemble of lenses, preferably in the form of Fresnel lenses, and/or a reflector and/or an ensemble of reflectors, and/or a sheetlike formation provided with cutouts. This decoration can be replaced at any time. In this context, there is no limit to the creativity of individuals having an artistic disposition. By combining papers and/or films of different color and light transmittance, it is possible to achieve the most amazing effects.

This lamp can be commercially used in an excellent manner as an advertising medium: advertising prints on paper and film can easily be inserted into the gap between the glass cylinders; films also in two layers, the one film being, for example, a basic pattern, for example including company emblems, the other being a film which is to be replaced more frequently such as a typewritten menu. Since the lamp can thus be customized very easily by inserting the decoration or the advertising medium, it can be manufactured as a mass-produced article and therefore be put on the market at a very economical price, as well.

Expediently used as inserts are papers and/or films which have a tendency to stretch back from their cylindrical shape into a plane shape due to their inner shape memory. Due to their inner tension, these inserts lie very well against the inner side of the outer glass cylinder and do not drop out when lifting the lamp. However, it is always expedient for the outer glass cylinder to have an inwardly directed thickening or rim at its lower end for holding the insert which is introduced between the two glass cylinders.

This lamp is designed in such a manner that the inwardly directed rim at the lower end of the inner hollow body constitutes the support of the light source.

In another preferred embodiment of this lamp, the outer hollow body has a bulbous shape or the shape of a spherical cap, the outer hollow body has an upper opening which has a smaller diameter than the lower opening, and the upper edge of the outer hollow body is fixedly joined to the upper edge of the inner hollow body to form one piece.

If the component parts of this lamp are composed of glass, then they are fused together to form one piece.

In this lamp, the light source can not only be a night light candle or a normal candle but also a light source which burns liquid fuel, or an electrically operated light source such as an incandescent lamp, a glow lamp, a light-emitting diode, or a discharge lamp.

If the light source of this lamp is an electrically operated light source which features a base including a rim and a spring collar, then the rim of the base engages on one side of the inwardly directed rim at the lower end of the inner hollow body, and the spring collar engages on the other side of the inwardly directed rim of the inner hollow body.

For lamps in which a decoration is inserted in the gap between the two hollow bodies, it is expedient for the outer hollow body to have an inwardly directed thickening or rim at its lower end for holding the insert which is introduced between the two glass cylinders.

In the case of a lamp which is operated with a night light candle, it is expedient for the hollow bodies to have a height and for the central hole in the rim of the inner hollow body to have a width which permits a night light candle, which is inserted in the lamp, to be lifted to such an extent that it can be lit by a match, a lighter or a lighting aid.

If the lamp is operated with an electric light source, it is expedient if the outer hollow body rests on a base through which an electric cable is led or if the outer hollow body has a notch or a hole in the lower region or at the lower edge for leading through an electric cable.

This lamp can also be advantageous for holding inserted decorations if the lower open space between the two hollow bodies is closed by an inserted ring.

The manufacture of this lamp is facilitated if, at the upper edge, the inner hollow body has an outwardly directed rim or if the outer hollow body has an inwardly directed rim which is fixedly joined to, or fused together with, the other hollow body, respectively, or if the inner hollow body carries an outwardly directed rim at the top and an inwardly directed rim at the bottom.

### BRIEF DESCRIPTION OF THE DRAWINGS

In the following, the nature of the present invention is explained in greater detail on the basis of exemplary embodiments which are schematically shown in the drawing.

FIG. 1 shows a section through a lamp which is equipped with a night light candle;

FIG. 2 shows a section through a lamp which is equipped with a normal candle;

FIG. 3 shows a section through a lamp which is equipped with an electrically operated light source;

FIG. 4 shows a section through a lamp having a bulbous outer hollow body; and

FIG. 5 shows a section through a lamp having a bulbous inner hollow body.

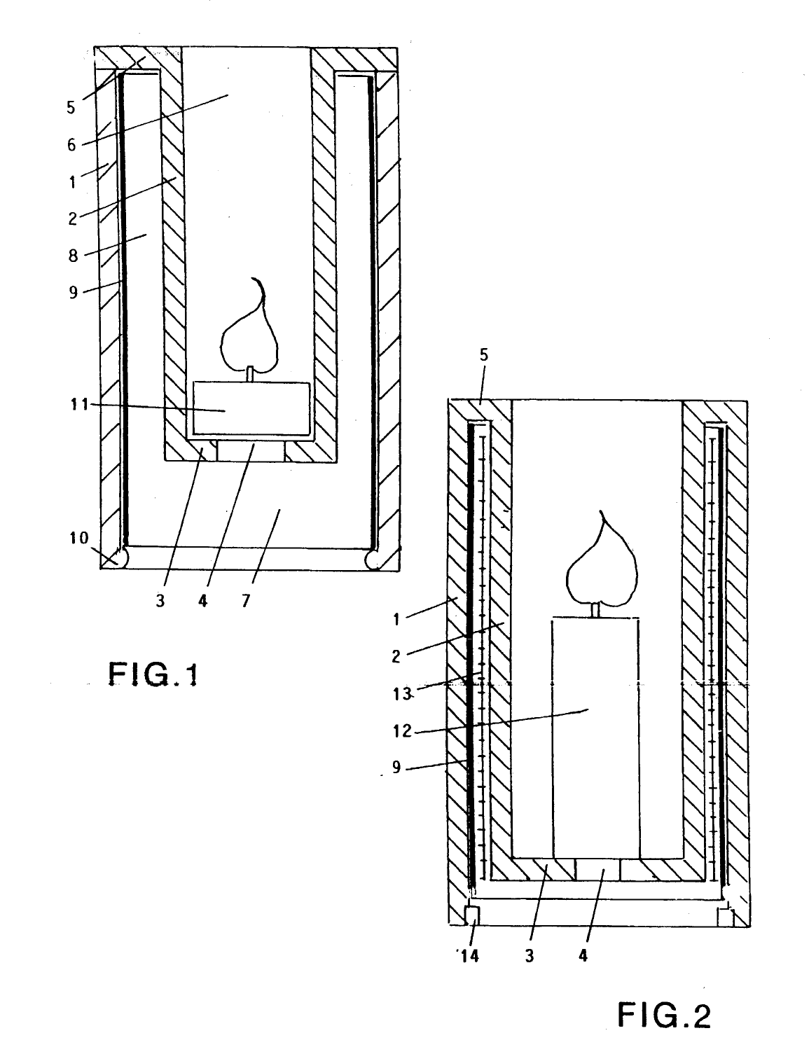

### DETAILED DESCRIPTION OF THE INVENTION

In outer glass cylinder 1, a further glass cylinder 2 is inserted which, at the lower or bottom end, has an inwardly directed rim 3 encircling a hole 4 and which, at the upper or top end, has an outwardly directed rim 5 which is fused together with outer glass cylinder 1 at the upper or top end thereof. This glass body has a upwardly open central interior space 6 above rim 3 and a downwardly open central interior space 7 below rim 3 as well as an annular hollow space 8 between glass cylinders 1 and 2 which leads downward into interior space 7. Inserted into this annular hollow space 8 is a printed light-transmissive film 9 which is pressed against the inner surface of outer glass cylinder 1 by its inherent restoring forces. At its lower or bottom edge, this outer glass cylinder 1 has an inwardly directed thickening 10 which hinders inserted film 9 from slipping out downward in the event that the lamp is lifted. Rim 3 carries a night light candle 11 as the light source.

The lamp of FIG. 2 has a similar design. It accommodates a normal candle 12. Rim 3 is situated deeper. A light guide system 13 which is made of clear plastic and inserted in annular hollow space 8 distributes the light generated by the candle over film 9. To be able to manufacture the light body from plastic by injection molding, a ring 14 is inserted at the lower or bottom end of cylinder 1.

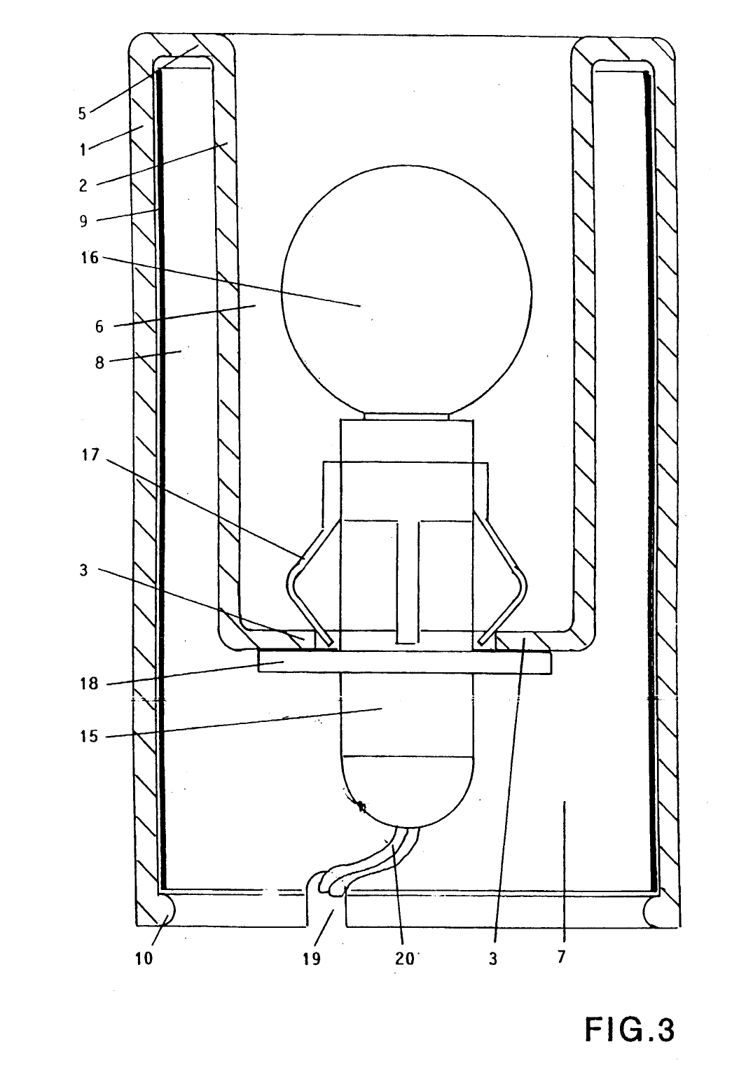

The lamp of FIG. 3 is equipped with an electric light source which is composed of a base 15 and an incandescent lamp 16 and which is designed in such a manner that the electrically operated light source has a base 15 including a rim 18 and a spring collar 17. Rim 18 of base 15 engages on one side of rim 3 of inner glass cylinder 2 and spring collar 17 engages on the other side of rim 3 of inner glass cylinder 2. Outer glass cylinder 1 has a notch 19 or a hole in the lower or bottom region or at the lower or bottom edge for leading through an electrical cable 20.

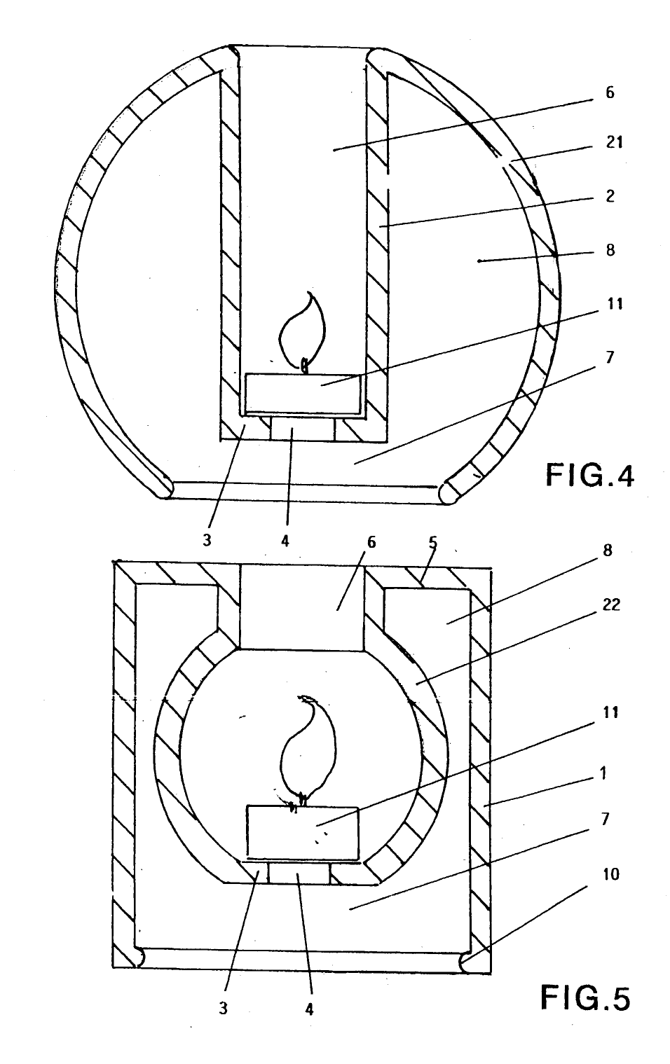

FIG. 4 shows another embodiment of the lamp in which outer hollow body 21 has a bulbous shape or the shape of a spherical cap and features an upper opening which has a smaller diameter than the lower opening, and in which the upper or top edge of outer hollow body 21 is fixedly joined to the upper or top edge of the inner hollow body 2 to form one piece.

FIG. 5 shows a further embodiment of the lamp in which the inner hollow body 22 has a bulbous shape.

The double-shell design of this lamp has the further advantage that the outer glass cylinder remains cool and can be touched with the hand even after a long operating time just as the decoration which is inserted in the annular hollow space.

### List of Reference Symbols

1 outer hollow body (glass cylinder)

2 inner hollow body (glass cylinder)

3 rim

4 hole

5 rim

6 upper central interior space

7 lower central interior space

8 hollow space between the hollow bodies (glass cylinders)

9 light-transmissive film

10 thickening

11 night light candle

12 normal candle

13 light guide system

14 ring

15 base.

16 incandescent lamp

17 spring collar

18 rim

19 cutout

20 cable

21 outer bulbous hollow body (glass cylinder)

22 inner bulbous hollow body (glass cylinder)

What is claimed is:

1. A lamp, comprising: an inner hollow body having a top end and a bottom end made of light-transmissive material, which accommodates a light source,
wherein the inner hollow body is surrounded by an outer light-transmissive hollow body having a top end and a bottom end; and
both hollow bodies interconnected at their top ends; the inner hollow body shorter than the outer hollow body and provided with an inwardly directed rim.

2. The lamp as recited in claim 1,
wherein the two hollow bodies are interconnected at their top ends via a ring made of light-transmissive material.

3. The lamp as recited in claim 2,
wherein the ring made of light-transmissive material is formed as an inwardly directed rim at the upper end of the outer hollow body.

4. The lamp as recited in claim 1,
wherein the inwardly directed rim at the bottom end of the inner hollow body comprises the support of the light source.

5. The lamp as recited in claims 1 and 4,
wherein the outer hollow body has a shape selected from the group consisting of a bulbous shape and a spherical cap shape;
the outer hollow body has an upper opening which has a smaller diameter than the lower opening; and the upper edge of the outer hollow body is fixedly joined to the upper edge of the inner hollow body to form one piece.

6. The lamp as recited in claim 1,
wherein the component parts of the lamp are comprised of glass and fused together to form one piece.

7. The lamp as recited in claim 1,
wherein the light source is selected from the group consisting of a night light candle, a normal candle, a light source which burns liquid fuel, or an electrically operated light source, an incandescent lamp, a glow lamp, a light-emitting diode, and a discharge lamp.

8. The lamp as recited in claim 7,
wherein the electrically operated light source has a base including a rim and a spring collar, the rim of the base engaging on one side of the inwardly directed rim at the lower end of the inner hollow body and the spring collar engaging on the other side of the inwardly directed rim of the inner hollow body.

9. The lamp as recited in claim 1,
wherein a decoration is inserted in the gap between the two hollow bodies.

10. The lamp as recited in claim 9,
wherein the decoration is selected from the group consisting of printed paper, painted paper, a film, a piece of textile, a lens, a plurality of lenses, a reflector, a plurality of reflectors, and a sheetlike formation provided with cutouts.

11. The lamp as recited in claim 1,
wherein the outer hollow body has an inwardly directed thickening or rim at its lower end for holding the insert which is introduced between the two hollow bodies.

12. The lamp as recited in claim 1,
wherein the hollow bodies have a height and the central hole in the rim of the inner hollow body has a width which permits a night light candle, inserted in the lamp, to be lifted to such an extent that it can be lit by a match, a lighter, or a lighting aid.

13. The lamp as recited in claim 1,
wherein the outer hollow body rests on a base through which an electric cable is led.

14. The lamp as recited in claim 1,
wherein the lower open space between the two hollow bodies is closed by an inserted ring.

15. The lamp as recited in claim 1,
wherein, at the top end, the inner hollow body has an outwardly directed rim which is fixedly joined to the other hollow body.

16. The lamp as recited in claim 1,
wherein the hollow bodies are made from different glass materials.

17. The lamp as recited in claim 1,
wherein the outer hollow body has a notch or a hole in the bottom end for leading through an electric cable.

18. The lamp as recited in claim 2,
wherein the ring made of light-transmissive material is formed as an outwardly directed rim at the top end of the inner hollow body.

19. The lamp as recited in claim 10, wherein the lens in a Fresnel lens.

20. The lamp as recited in claim 1,
wherein, at the top end, the outer hollow body has an inwardly directed rim which is fixedly joined to the other hollow body.
